(19) United States
(12) Patent Application Publication
(10) Pub. No.: US 2006/0064314 A1
(43) Pub. Date: Mar. 23, 2006

(54) Multimedia floral merchandising system

(76) Inventors: Jason Levin, Carlsbad, CA (US); David Levin, Aruada, CO (US)

Correspondence Address: FISH & RICHARDSON, PC, P.O. BOX 1022, MINNEAPOLIS, MN, 55440-1022, US

(21) Appl. No.: 11/225,382

(22) Filed: Sep. 12, 2005

Related U.S. Application Data
(60) Provisional application No. 60/608,760, filed on Sep. 10, 2004.

(51) Int. Cl. G06Q 99/00

(52) U.S. Cl. 705/1

(57) ABSTRACT

A graphical user interface for a floral merchandising system. The graphical user interface includes a selection bar having one or more floral product tabs, each floral product tab representing one of a number of floral products. The graphical user interface further includes one or more user-selectable item buttons, each item button corresponding to one of the number of floral products, and one or more windows for displaying information about one of the number of floral products according to a user selection.

### CROSS REFERENCE TO RELATED APPLICATIONS

The present application claims priority under 35 U.S.C. §119 to U.S. Provisional Application Ser. No. 60/608,760, filed Sep. 10, 2004, entitled MULTIMEDIA FLORAL MERCHANDISING SYSTEM, the disclosure of which is incorporated herein by reference.

### BACKGROUND

The floral merchandising business in a point-of-sale context is historically one of tactile sensory fulfillment in connection with physically-present goods in a static display. A static display provides a group of floral arrangements in a stand or some other type of kiosk, and the consumer generally selects the desired floral arrangement from the group.

Floral vendors often provide point-of-sale merchandising of floral arrangements in a store such as a supermarket. However, floral arrangements must compete with a plethora of other perishable and nonperishable goods for a consumer's attention. Very seldom does a static display of flowers influence consumer behavior—indeed, a great majority of floral consumers determine their purchase prior to having any access to such static displays.

### SUMMARY

This document discloses an interactive multimedia floral merchandising system. The system includes a rich communication medium to influence a consumer at the point of sale, and also includes education for consumers on the benefits and value of fresh-cut flowers, such as design ideas, lifestyle-oriented pictures or video, fun facts, etc. According to an aspect of the interactive multimedia floral merchandising system, a goal is to convert browsers to buyers, and to transform a traditional static floral display into a primary destination, such as within a store or group of stores.

According to one aspect, a floral merchandising system includes a graphical user interface display and a client computer. The client computer is configured to generate a graphical user interface for the graphical user interface display. The graphical user interface includes a selection bar having one or more floral product tabs, each floral product tab representing one of a number of floral products. The graphical user interface further includes one or more user-selectable item buttons, each item button corresponding to one of the number of floral products, and one or more windows for displaying information about one of the number of floral products according to a user selection.

According to another aspect, a floral merchandising method includes the steps of generating the graphical user interface for a graphical user interface display, and displaying the graphical user interface. In yet another aspect, a computer program product, tangibly embodied in a machine readable medium, is described. The computer program product includes instructions operable to generate the graphical user interface for the graphical user interface display, and display the graphical user interface in the graphical user interface display.

The computer program product further includes instructions operable to receive user input via the graphical user interface display, and to generate the graphical user interface based on the received user input.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 shows a multimedia floral merchandising system according to an exemplary embodiment.

FIG. 2 shows an exemplary embodiment of a multimedia floral merchandising network.

FIG. 3 shows a graphical user interface of a multimedia floral merchandising system.

Like reference symbols in the various drawings indicate like elements.

### DETAILED DESCRIPTION

This document describes a system to digitally broadcast merchandising information regarding fresh cut flowers direct to the point-of-sale, and enable interaction by shopper (via barcode scan, keyboard, touch screen, etc.) to view desired content (e.g., arrangement ideas, design tips, etc.).

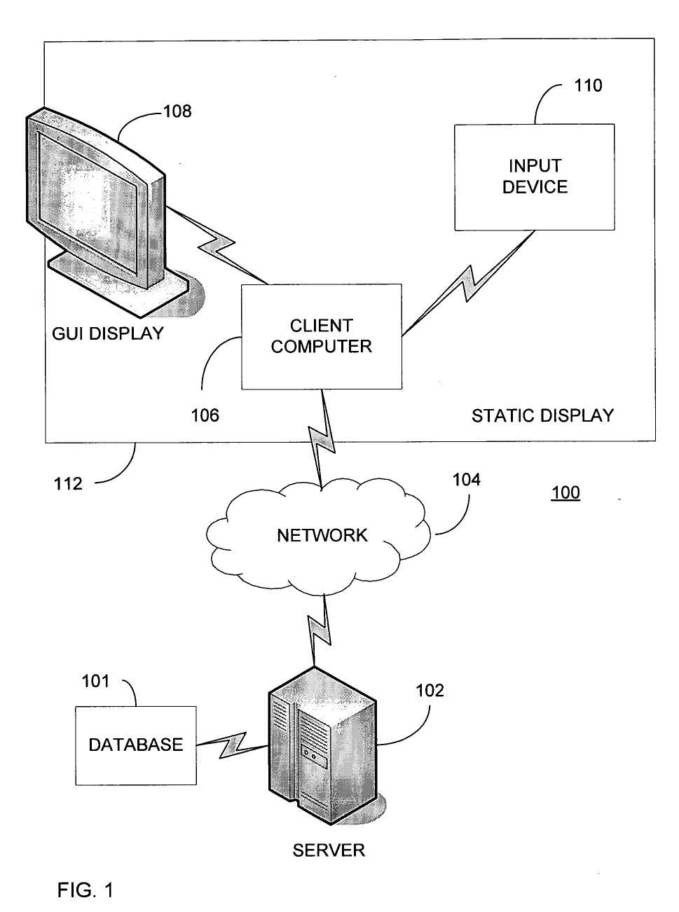

FIG. 1 shows a multimedia floral merchandising system 100 according to an exemplary embodiment. The system 100 includes a centralized server 102 communicating with one or more client computers 106 through a network. The network 106 can be the Internet, a local area network (LAN), a wide area network (WAN), or any other type of data communication network. The server 102 can include server software programs and server hardware, and represents one or more physical server devices. The server 102 is connected to a database 101, which may or may not be integrated with the server 102.

The client computer 106 includes hardware and software for storing an executing a local application for displaying floral information. The client computer 106 includes software and hardware for generating a graphical user interface (GUI) and display signals, for rendering on a GUI display 108. The client computer 106 receives input signals, such as queries, instructions, commands, etc., from a user via an input device 110. The input device 110 can be a keyboard, a mouse or other pointer device, a scanner such as a barcode scanner, a touch screen, etc. In some embodiments, the input device 110 is integrated with the GUI display 108, such as in a touch-screen monitor, for example. The client computer 106, GUI display 108 and input device 110 can be physically located with or proximate to a static display 112 such as a flowerbox display, display shelving, etc.

The system 100 includes one or more software modules for executing a local merchandising and/or point-of-sale application. These software modules include, without limitation, a player program that is executed on the client computer 106. The player program includes pre-designed templates or “skins” that enable basic inputs (graphics, digital videos, text, macromedia flash) to be arranged and displayed as a user interface. The templates are easily defined or modified, and can be stored locally in the client computer 106, or centrally in the server 102 or database 101. User inputs can be stored in a historical record of the database 101, to analyze and improve or refine the information provided to a user on the GUI display 108.

The software modules further include an authoring tool for designing the templates, loading content, etc. The authoring tool may also be locally or centrally stored and accessible via the client computer 106, or stored remotely and accessible via the network 104. Another software module is a Scheduling and Network Management (SNM) program, used to propagate content and modifications to the one or more client computers 106. In an example, the SNM program runs on the server 102, and is accessible by an administrator or a user having a heightened access right.

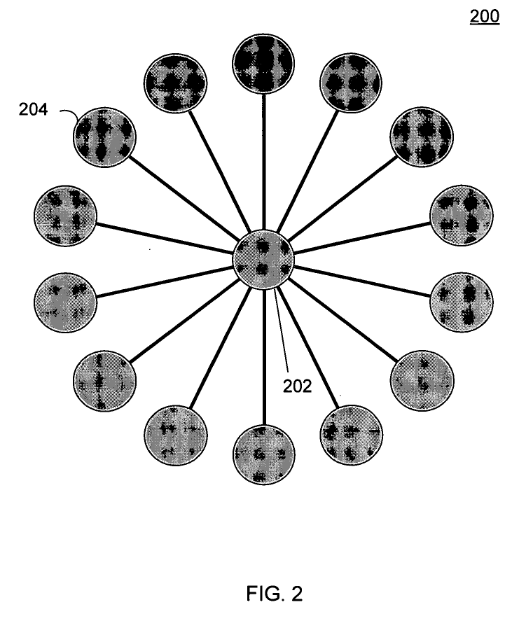

FIG. 2 shows an exemplary embodiment of a multimedia floral merchandising network 200, in which a number of systems 204 are connected to a central server 202. Each line represents a communication path that can include any number of links and data networks. Each system 204 may include the components and functionality of the system 100 described above.

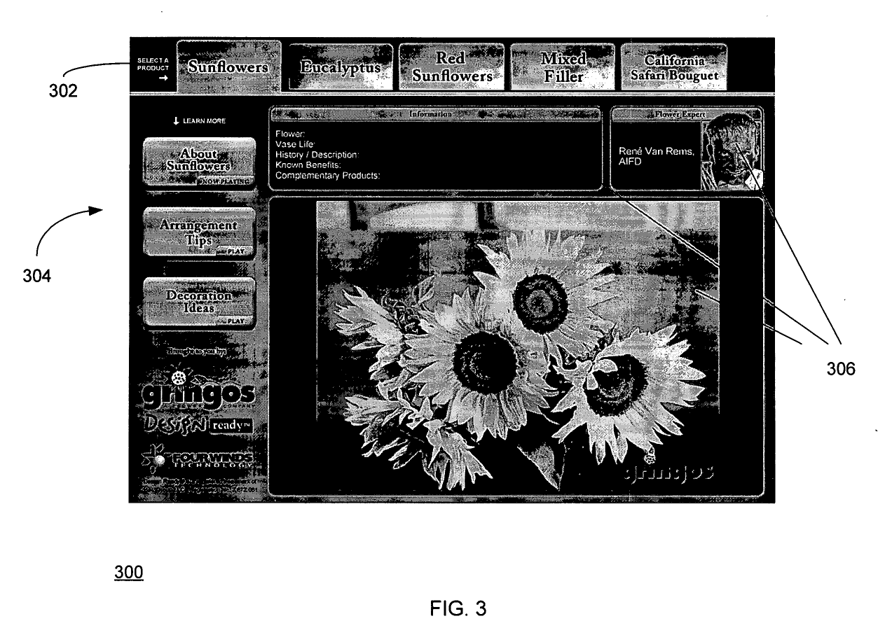

FIG. 3 shows a graphical user interface 300 to illustrate some of the functions and information provided by the merchandising system. The GUI provides separate data and graphics, as shown in FIG. 3. The GUI 300 includes a floral product selection bar 302 having one or more floral product tabs associated with floral product categories, product groups, or products. The GUI 300 further includes a set of one or more user-selectable item buttons 304, preferably corresponding to a floral product represented in the floral product selection bar 302, and one or more windows 306 that display floral content information, in such formats as video, pictures, graphics, audio, etc. The windows 306 can be single use or multi-use, of a uniform size, format-specific size, or user-configurable size.

The system enables an advertiser to provide data, text, digital video, macromedia flash, images and photos relating to floral merchandising. The advertiser can also provide system parameters and layout definitions. The system further enables a consumer to provide inputs such as a product barcode or other identifier, and to select a category or item selection via the input device for display in the GUI display.

The GUI display displays information pertaining to the floral product selected such as a type of flowers being purchased by the consumer according to a barcode label, arrangement tips for the particular purchased item, design ideas, and general flower information. Accordingly, the system provides general information to attract consumers to the point of sale system, and then can provide specific information about an item selected by the consumer for purchase.

The system is adapted to communicate key flower attributes such as vase life, complementary flower suggestions, and price, all based on a media-rich presentation. The system can also describe consumer benefits of fresh cut flowers, augmented with lifestyle photos, videos, and shopper testimonials. This information is generated and supplied based on user queries and other inputs, such as from a bar code to identify a product of interest to a consumer.

The merchandising system and its various enhancements are not limited to use with the hardware and software described above; they may find applicability in any computing or processing environment and with any type of machine that is capable of running machine-readable instructions. All or part of the merchandising system can be implemented in digital electronic circuitry, or in computer hardware, firmware, software, or in combinations thereof.

All or part of the merchandising system can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with the merchandising system can be performed by one or more programmable processors executing one or more computer programs to perform the functions of the merchandising system. The method steps can also be performed by, and process 40 can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include a processor for executing instructions and one or more storage area devices for storing instructions and data.

Generally, a computer will also include, or be operatively coupled to receive data from, or transfer data to, or both, one or more mass storage devices for storing data, e.g., magnetic, magneto-optical disks, or optical disks. Information carriers suitable for embodying computer program instructions and data include all forms of non-volatile storage area, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks.

All or part of the merchandising system can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the merchandising system, or any combination of such back-end, middleware, or front-end components. The components of the system can be interconnected by any form or medium of digital data communication, e.g., a communication network. Examples of communication networks include a LAN and a WAN, e.g., the Internet.

Method steps associated with the merchandising system can be rearranged and/or one or more such steps can be omitted to achieve the same, or similar, results to those described herein. The merchandising system may be fully automated, meaning that it operate without user intervention, or interactive, meaning that all or part of the merchandising system may include some user intervention.

Although a few embodiments have been described in detail above, other modifications are possible. Other embodiments may be within the scope of the following claims.

1. A floral merchandising system comprising:
a graphical user interface display; and
a client computer configured to generate a graphical user interface for the graphical user interface display, the graphical user interface including:
a selection bar having one or more floral product tabs, each floral product tab representing one of a number of floral products;
one or more user-selectable item buttons, each item button corresponding to one of the number of floral products; and
one or more windows for displaying information about one of the number of floral products according to a user selection.

2. A system in accordance with claim 1, further comprising an input device for receiving the user selection from a user.

3. A system in accordance with claim 2, wherein the input device is a touch screen display that displays the graphical user interface.

4. A system in accordance with claim 1, wherein the client computer further includes a player program that generates one or more templates, each template configured to arrange content in the graphical user interface.

5. A system in accordance with claim 4, wherein the client computer further includes an authoring tool for designing the one or more templates and for loading the content into the one or more templates.

6. A system in accordance with claim 5, wherein the authoring tool is stored locally in the client computer.

7. A system in accordance with claim 5, wherein the authoring tool is stored remotely from the client computer and accessible by the client computer via a network.

8. A system in accordance with claim 1, further comprising a database storing one or more templates of the graphical user interface.

9. A floral merchandising method comprising:
generating a graphical user interface for a graphical user interface display, the graphical user interface including:
a selection bar having one or more floral product tabs, each floral product tab representing one of a number of floral products;
one or more user-selectable item buttons, each item button corresponding to one of the number of floral products; and
one or more windows for displaying information about one of the number of floral products according to a user selection; and
displaying the graphical user interface.

10. A method in accordance with claim 9, further comprising receiving user input signals for selecting at least one of the one or more user-selectable item buttons.

11. A method in accordance with claim 10, further comprising displaying information about one of the number of floral products based on the user input signals.

12. A method in accordance with claim 9, further comprising generating one or more templates, each template configured to arrange content in the graphical user interface.

13. A method in accordance with claim 12, further comprising providing an authoring tool to a user for designing the one or more templates and for loading the content into the one or more templates.

14. A method in accordance with claim 9, further comprising retrieving, from a database, the information about one of the number of floral products according to the user selection.

15. A method in accordance with claim 14, further comprising displaying the information about one of the number of floral products according to the user selection.

16. A method in accordance with claim 9, further comprising storing user inputs in a historical file in a database.

17. A method in accordance with claim 16, further comprising analyzing the historical file to refine the graphical user interface.

18. A computer program product, tangibly embodied in a machine readable medium, comprising instructions operable to:
generate a graphical user interface for a graphical user interface display, the graphical user interface including:
a selection bar having one or more floral product tabs, each floral product tab representing one of a number of floral products;
one or more user-selectable item buttons, each item button corresponding to one of the number of floral products; and
one or more windows for displaying information about one of the number of floral products according to a user selection; and
display the graphical user interface.

19. A computer program product in accordance with claim 18, further comprising instructions operable to receive user input via the graphical user interface display.

20. A computer program product in accordance with claim 19, further comprising instructions operable to generate the graphical user interface based on the received user input.
